(19) United States
(12) Patent Application Publication
(10) Pub. No.: US 2013/0344885 A1
(43) Pub. Date: Dec. 26, 2013

(54) ELECTRONIC TRACKING DEVICE WITH WIRELESS COMMUNICATIONS PROTOCOL TRANSLATION CIRCUITRY AND ASSOCIATED METHODS

(71) Applicants: Joseph PARISI, Del Ray Beach, FL (US); Robert FELTHAM, Ft. Lauderdale, FL (US)

(72) Inventors: Joseph PARISI, Del Ray Beach, FL (US); Robert FELTHAM, Ft. Lauderdale, FL (US)

(73) Assignee: PearTrack America, LLC, Del Ray Beach, FL (US)

(21) Appl. No.: 13/533,165

(22) Filed: Jun. 26, 2012

(51) Int. Cl. H04W 4/02

(52) U.S. Cl. 455/456.1

(57) ABSTRACT

An electronic tracking device includes a housing, a motherboard, and a daughterboard coupled to the motherboard. The motherboard includes processing circuitry configured to operate using a first command set corresponding to a first wireless communications protocol. The daughterboard includes tracking circuitry, wireless transceiver circuitry and translation circuitry. The wireless transceiver circuitry is coupled to the tracking circuitry and is configured to operate using a second command set corresponding to a second wireless communications protocol. The translation circuitry is coupled between the wireless transceiver circuitry and the processing circuitry to provide bidirectional translation between the first and second command sets.

### FIELD OF THE INVENTION

The present invention relates to the field of electronic tracking devices, and more particularly, to an electronic tracking device providing tracking information via wireless communications networks and associated methods.

### BACKGROUND OF THE INVENTION

Shipping containers are used to transport a large part of the commerce entering and leaving the United States, as well as transiting or moving within the United States. It is estimated that there are tens of millions of shipping containers moving in global commerce. Shipping containers are advantageous in that they greatly reduce the number of times goods need to be loaded and unloaded during transport.

In today's security conscious transportation environment, there is a strong demand to cost-effectively and accurately track and monitor the contents of containerized shipments. This need exists both in the United States and abroad.

Wireless asset monitoring devices have been developed which may be attached to a mobile asset, such as a shipping container, to allow a user to determine the location of the asset and control certain functions of the asset. These devices typically obtain position information using global positioning system (GPS) satellite signals and transmit the position information using wireless cellular communications technology. One such system, wherein a user may access a web page via the Internet to track an asset, is described in U.S. Pat. No. 7,102,510.

A smart container monitoring system is also provided in U.S. Published Patent Application No. 2008/0278318. A remotely monitored shipping container includes a GPS antenna for receiving signals relating to location of the shipping container and location reporting circuitry responsive to an output from the GPS antenna for providing information to an RF transmitter. The RF transmitter may communicate via at least one of cellular, radio and satellite communications networks.

Yet another approach for monitoring and tracking a shipping container is provided by PearTrack TeleAsset™ offered by Minorplanet Ltd. with headquarters located in the United Kingdom. The PearTrack TeleAsset™ system provides time sensitive information, such as GPS enhanced event alerts and usage information, allowing the user to effectively manage their assets from a single web-based portal. In particular, the PearTrack TeleAsset™ system provides an electronic tracking device that is fitted discretely to each asset to monitor alarms, gather data, and communicate this information to a PearTrack™ web portal using general packet radio service (GPRS) via the GSM mobile network.

The PearTrack™ electronic tracking device operates with a GSM cellular communications protocol, which is commonly used in Europe. This protocol is supported by a GR47/GR48 cellular communications module mounted on a motherboard in the PearTrack™ electronic tracking device. The GR47/GR48 module is provided by Sony Ericsson Mobile Communications with headquarters located in the United Kingdom, and is configured to operate using an AT modem command set corresponding to the GSM cellular communications protocol.

While each of the above-described electronic tracking devices uses cellular communications to monitor and track location of a shipping container, they are limited to a particular cellular communications protocol. However, at the present time, there is no one common cellular communications protocol that is in use throughout the world. Instead, different regions of the world use different cellular communications protocols. Consequently, there is need for a portable electronic tracking device for use with a particular cellular communications protocol to be able to operate with a different cellular communications protocol.

### SUMMARY OF THE INVENTION

In view of the foregoing background, it is therefore an object of the present invention to provide a portable electronic tracking device that is compatible with different cellular communications protocols.

This and other objects, advantages and features in accordance with the present invention are provided by an electronic tracking device comprising a housing, a motherboard carried by the housing and comprising processing circuitry configured to operate using a first command set corresponding to a first wireless communications protocol, and a daughterboard coupled to the motherboard. The daughterboard may comprise tracking circuitry, wireless transceiver circuitry coupled to the tracking circuitry and configured to operate using a second command set corresponding to a second wireless communications protocol, and translation circuitry coupled between the wireless transceiver circuitry and the processing circuitry to provide bidirectional translation between the first and second command sets.

In some embodiments, the daughterboard may be configured to interface with a motherboard from an existing electronic tracking device. The translation circuitry on the daughterboard advantageously allows the electronic tracking device to support a cellular communications protocol that is different than the cellular communications protocol supported by the motherboard. For example, the processing circuitry on the motherboard may be configured to operate using an AT command set corresponding to the GSM cellular communications protocol, whereas the wireless transceiver circuitry may be configured to operate using an AT command set corresponding to the CDMA cellular communications protocol.

The motherboard may further comprise a motherboard connector, and the daughterboard may further comprise a daughterboard connector mated with the motherboard connector. The tracking circuitry may comprise GPS circuitry. The electronic tracking device may further comprise a GPS antenna carried by the housing and coupled to the GPS circuitry.

The electronic tracking device may further comprise at least one battery carried by the housing and coupled to the motherboard and daughterboard. The housing may comprise mating first and second housing portions. The first portion may carry the motherboard and daughterboard, and the second portion may carry the at least one battery. A partition may be between the first and second housing portions.

Another aspect is directed to a method for operating an electronic tracking device as described above. The method may comprising operating the processing circuitry using a first command set corresponding to a first wireless communications protocol, operating the wireless transceiver circuitry using a second command set corresponding to a second wireless communications protocol, and operating the translation circuitry coupled between the wireless transceiver circuitry and the processing circuitry to provide bidirectional translation between the first and second command sets.

### BRIEF DESCRIPTION OF THE DRAWINGS

FIG. 1 is a block diagram of an electronic tracking device in accordance with the present invention.

FIG. 2 is an exploded perspective view of the electronic tracking device as shown in FIG. 1.

FIG. 3 is a side view of the electronic tracking device as shown in FIG. 2.

FIG. 4 is a flowchart illustrating a method for operating a portable electronic tracking device in accordance with the present invention.

FIG. 5 is a state diagram for the electronic tracking device in accordance with the present invention.

FIG. 6 is a timing diagram for turning on the wireless transceiver circuitry on the daughterboard in accordance with the present invention.

FIG. 7 is a timing diagram for turning off the wireless transceiver circuitry on the daughterboard in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

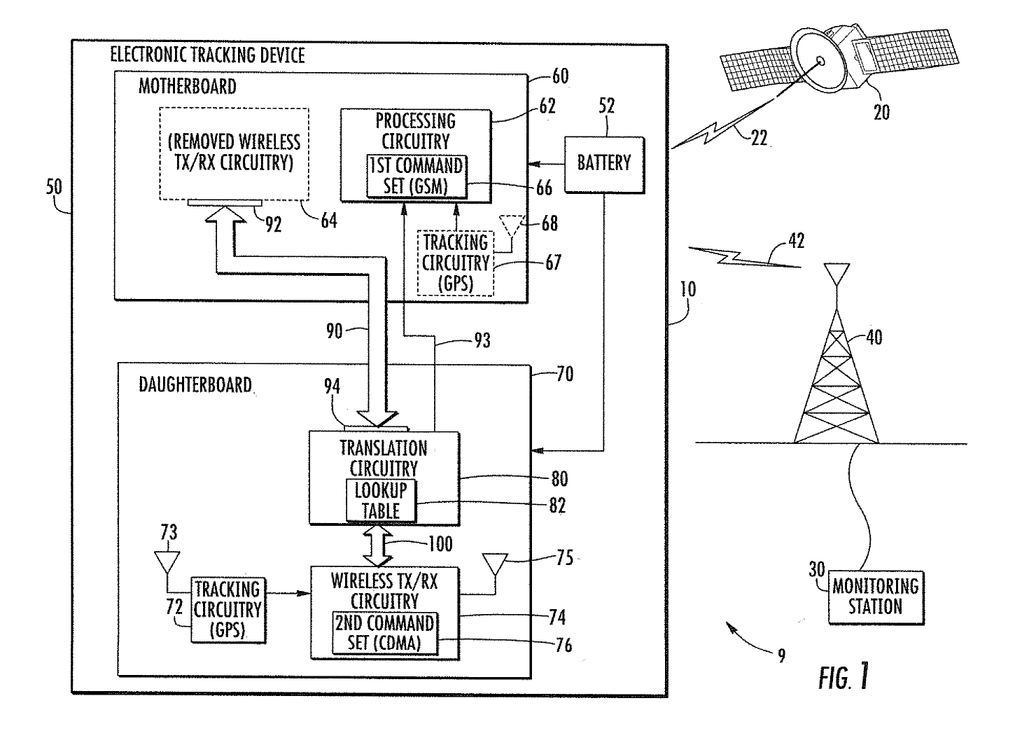

Referring initially to FIG. 1, a communications system 9 including an electronic tracking device 10 will now be discussed. The electronic tracking device 10 is an asset monitoring device that is to be attached to a mobile asset, such as a shipping container. The electronic tracking device 10 obtains position information using satellite signals 22 received from multiple GPS satellites 20, one of which is illustrated in FIG. 1. Position and other monitored information may be transmitted to a monitoring station 30 using wireless cellular communications technology. Signals 42 transmitted from the electronic device 10 are received by a base station 40 which then interfaces with the monitoring station 30 via intervening communications infrastructure.

The electronic tracking device 10 includes a housing 50, and a motherboard 60 and daughterboard 70 carried by the housing. At least one battery 52 is carried by the housing 50 and is coupled to the motherboard 60 and daughterboard 70. The motherboard 60 includes processing circuitry 62 to operate using a first command set 66 corresponding to a first wireless communications protocol. The daughterboard 70 is coupled to the motherboard 60 and includes tracking circuitry 72, and wireless transceiver circuitry 74 coupled to the tracking circuitry to operate using a second command set 76 corresponding to a second wireless communications protocol. Translation circuitry 80 is coupled between the wireless transceiver circuitry 74 and the processing circuitry 62 to provide bidirectional translation between the first and second command sets. Also, the motherboard 60 and daughterboard 70 each include a respective printed circuit board (PCB) on which their respective components are mounted.

The daughterboard 70 is configured to interface with a motherboard, such as, for example, from an existing electronic tracking device. In one embodiment, the motherboard 60 may be from the PearTrack™ electronic tracking device, as discussed in the background. The PearTrack™ electronic tracking device may be anyone of a family of available PearTrack™ devices having part numbers PT-1000, PT-700, PT-500, PT-300 and PT-90, for example. For the daughterboard 70 to interface with the motherboard 60, the GR47/GR48 wireless transceiver circuitry, which is included in the PearTrack™ electronic tracking devices and which supports the GSM cellular communications protocol, is removed from the motherboard 60 to expose a pin-out interface 64 that corresponds to the removed GR47/GR48 wireless transceiver circuitry.

The translation circuitry 80 on the daughterboard 70 is coupled to the wireless transceiver circuitry pin-out interface 64 via a motherboard cable 90. One end of the motherboard cable 90 has a motherboard connector 92 coupled to the pin-out interface 64, with the other end of the cable having a daughterboard connector 94 coupled to the translation circuitry 80. The translation circuitry 80 is also coupled to the wireless transceiver circuitry 74 on the daughterboard 70 via a daughterboard cable 100. In one embodiment, the wireless transceiver circuitry 74 on the daughterboard 70 may be a CC864 module provided by Telit Communications S.p.A. with headquarters located in Italy, and which supports the CDMA cellular communications protocol. An antenna 75 is coupled to the wireless transceiver circuitry 74. Of course in other embodiments, other transceiver circuitry could be used as will be appreciated by those skilled in the art.

The translation circuitry 80 on the daughterboard 70 advantageously allows the electronic tracking device 10 to support a cellular communications protocol that is different than the cellular communications protocol supported by the motherboard 60. More particularly, the processing circuitry 62 on the motherboard 60 is configured to operate using an AT command set 66 corresponding to the GSM cellular communications protocol, whereas the wireless transceiver circuitry 74 on the daughterboard 70 is configured to operate using an AT command set 76 corresponding to the CDMA cellular communications protocol. As will be appreciated by those skilled in the art, AT command sets for GSM and CDMA are examples of modem command sets.

Since the processing circuitry 62 on the motherboard 60 processes all system requirements based on the AT command set for the GSM protocol, the translation circuitry 80 translates the GSM AT commands to equivalent CDMA AT commands for interfacing with the wireless transceiver circuitry 74 on the daughterboard 70, and vice-versa.

In other words, the translation circuitry 80 may be a microprocessor configured as an intelligent translation unit that translates the GSM AT commands into equivalent operational functions for the connected wireless transceiver circuitry 74 (e.g., the CC864 CDMA module). The translation circuitry 80 then translates the responses from the wireless transceiver circuitry 74 and responds to the motherboard 60 with the proper GSM AT command responses in such a manner to satisfy the GSM command set. The bidirectional translation and functional operations are performed in such a manner as to maintain the timing requirements of the processing circuitry 62 on the motherboard 60.

The wireless transceiver circuitry 74 on the daughterboard 70 is not limited to CDMA. For example, there is a family or series of Telit CC864 modules with the same footprint so that anyone of which may be selected so that other cellular communications protocols may be supported, such as wideband CDMA, UTMS/HSDPA, and LTE, as readily appreciated by those skilled in the art. The wireless transceiver circuitry 74 may also be selected to support U.S. based GSM, and even satellite communications.

The tracking circuitry 72 on the daughterboard 70 may include GPS circuitry. A GPS antenna 73 is carried by the housing 50 and is coupled to the GPS tracking circuitry 72. The tracking circuitry 72 is schematically illustrated as being separate from the wireless transceiver circuitry 74, however, the tracking circuitry may be included within a common module that also includes the wireless transceiver circuitry 74. In either configuration, the GPS data is provided to the translation circuitry 80 via the daughterboard cable 100. From the translation circuitry 80, the GPS data is provided to the processing circuitry 62 on the motherboard 60 via a dedicated data path 93. The dedicated data path 93 may be connected to a UART interface on the processing circuitry 62.

Alternatively, separate tracking circuitry 67 may be included on the motherboard 60. The separate tracking circuitry 67 may include GPS circuitry, and is coupled to the processing circuitry 62 via the same UART interface as would have been used for the tracking circuitry 72 on the daughterboard 70. A GPS antenna 68 is carried by the housing 50 and is coupled to the GPS tracking circuitry 67.

The translation circuitry 80 may include multiple UART interfaces. One of the UART interfaces may be coupled to the motherboard 60 via the motherboard cable 90. Another one of the UART interfaces is coupled to the wireless transceiver circuitry 74 via the daughterboard cable 100. The motherboard cable 90 may be a 60 pin interface, whereas the daughterboard cable 100 may be an 80 pin interface. For the illustrated example, the translation circuitry 80 translates the GSM AT commands for the removed GR47/GR48 GSM module into equivalent operational functions for the wireless transceiver circuitry 74 (e.g., the CC864 CDMA module) on the daughterboard 70.

The translation circuitry 80 translates the responses from the wireless transceiver circuitry 74 on the daughterboard 70 and responds to the processing circuitry 62 on the motherboard 60 with the proper GSM AT command responses to satisfy the GSM command set. These bidirectional translation and functional operations are performed to maintain the timing requirements of the motherboard 60.

When the wireless transceiver circuitry 74 on the daughterboard 70 is powered up, its carrier network connection may be verified before a data session is initiated. This network verification will be used to verify the type of service that is available prior to establishing a data connection/data-tunnel to the backend server at the monitoring station 30. The AT commands translated from the GSM AT command set are executed to create a data connection/tunnel to the backend main server using either TCP/IP protocols or SMS messaging on the CDMA cellular communications protocol.

The translation circuitry 80 seamlessly transfers the data stream in both directions while monitoring the data stream for end of data connection commands so that it can gracefully disconnect the data connection in compliance with the requirements of the communications carrier provider. The translation circuitry 80 gracefully connects/disconnects from the carriers' networks to acquire certification for use on the carrier network and to maintain the carrier certification.

Communications between the translation circuitry 80 and the motherboard 60 may be via a standard TTL serial data interface. The removed wireless transceiver circuitry (e.g., the GR47/GR48 GSM module) has 3 UARTS but the motherboard 60 only connects to one of the UARTs via pins 41, 42 by way of a standard TTL connection. This UART interface has a full RS232 capability and is used for all on and off line communications. The processing circuitry 62 on the motherboard 60 communicates to the GR47/GR48 GSM module at a 9600 baud rate and does not require any hardware flow control. The processing circuitry 62 on the motherboard 60 may run on 3.3 volts. The wireless transceiver circuitry 74 on the daughterboard 70 (e.g., the CC864 CDMA module) has a UART interface for data and a USB port. The USB port can be used for provisioning and diagnostics.

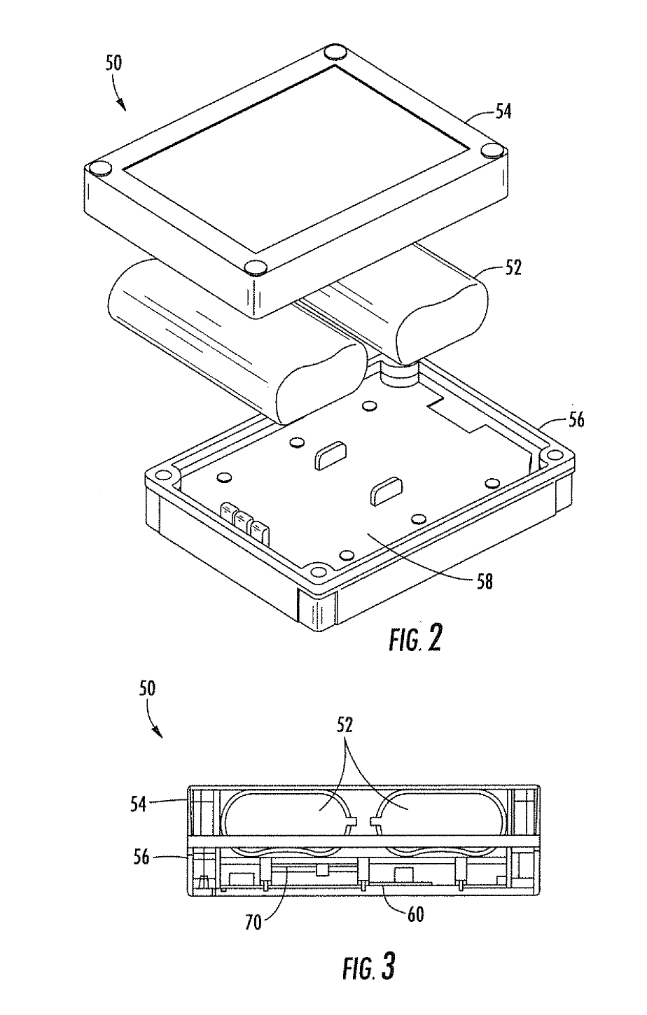

Referring now additional to FIGS. 2 and 3, the housing 50 includes mating first and second housing portions 54, 56. The first housing portion 54 carries the motherboard 60 and daughterboard 70. The second housing portion 56 carries the batteries 52. A partition 58 is between the first and second housing portions 54, 56.

The partition 58 advantageously shrouds the antennas 73, 75, the motherboard 60 and the daughterboard 70. The partition 58 is secured to the first housing portion 54. This may be accomplished using tamperproof screws. The separation between the first and second housing portions 54, 56 allows the batteries 52 to be serviced while diminishing the potential for a customer to tamper with the electronic components which are fixed on the underside of the partition 58. Although not illustrated, snap fit caps may also be used to cover the tamperproof screws. This secure fit with the snap fit caps will make it necessary to pry off the cap to unscrew the enclosure. Prying off the cap will cause the plastic cap to stress leaving a blemish or stress mark, making it evident that an attempt was made to open the unit.

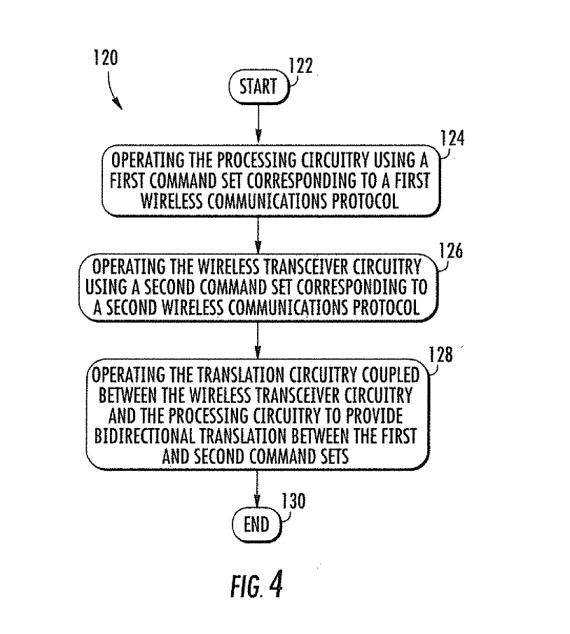

Another aspect is directed to a method for operating an electronic tracking device 10 as described above. Referring now to the flowchart 120 illustrated in FIG. 4, from the start (Block 122), the method comprises operating the processing circuitry 62 using a first command set 66 corresponding to a first wireless communications protocol at Block 124, and operating the wireless transceiver circuitry 74 using a second command set 76 corresponding to a second wireless communications protocol at Block 126. The method further comprises operating the translation circuitry 80 coupled between the wireless transceiver circuitry 74 and the processing circuitry 62 at Block 128 to provide bidirectional translation between the first and second command sets 66, 76. The method ends at Block 130.

The electronic tracking device 10 will now be discussed in greater detail in terms of software specifications, communications requirements and hardware specifications. The software specifications will be discussed first.

The processing circuitry 62 on the motherboard 60 handles all communications. Data may be transmitted for processing by the PearTrack™ back office system by way of a GPRS data call as facilitated by the local GSM network, and as an SMS text message via the local GSM network. Commands are sent from the back office system (e.g., the monitoring station 30) to the motherboard 60 via SMS text messaging, or during a mobile originated GPRS data session. The motherboard 60 default communications method is GPRS, however, upon request the motherboard can be configured to operate exclusively via SMS text messaging. For the CDMA market, a 1XRTT data call will be initiated.

The software for the daughterboard 70 will operate as a state machine with appropriate IRQs for data handling. There are a number of states, some of which are defined as follows.

In the Init State, the electronic tracking device 10 is powered up so that it can connect to the cellular network. The electronic tracking device 10 exits the Init State and enters a Normal Operation Mode while it waits for AT commands from the processing circuitry 62.

A Manufacturing Diagnostic Mode is reserved for use at the factory and applies to the debug port for connecting to the wireless transceiver circuitry 74 on the daughterboard 70. This mode is typically reserved for provisioning and debug during development, and uses the USB pbrt of the CC864 CDMA module.

In an Engineering Mode, the electronic tracking device 10 stays awake allowing diagnostics to be performed.

In a Normal Operating Mode, the following states are used. These states may also be used in the engineering mode. In a Comm State, the communications ports are restored to a default mode awaiting data from the communications ports to process.

In an Idle State, while waiting for GSM TX, the daughterboard 70 is waiting for commands from the motherboard 60. Once the command terminator is received, the state changes to Master AT command verification.

In a GSM AT Command Verification, the received Master AT command is verified. If it is legitimate, then a change is made from a Translation to a Slave State.

In a Translation to CDMA State, a GSM AT command is translated to match a supported CDMA AT command.

In a Transmit to Slave State, the translated AT command is transmitted to the daughterboard 70 and then there is a wait period for the daughterboard processing and acknowledgement to be performed.

In a Wait on Slave Ack State, the daughterboard 70 processes the command and acknowledge. Once acknowledged, the acknowledgement is translated and sent back to the motherboard 60.

In a Translate to GSM AT command, CDMA Acks and AT responses are translated, i.e., incoming text messages, etc., into GSM formats and are provided back to the motherboard 60.

In a Transmit to a Master State, the translated Slave commands are sent to the motherboard 60.

In a Power Down State, the wireless transceiver circuitry is powered down for a clean disconnect from the network.

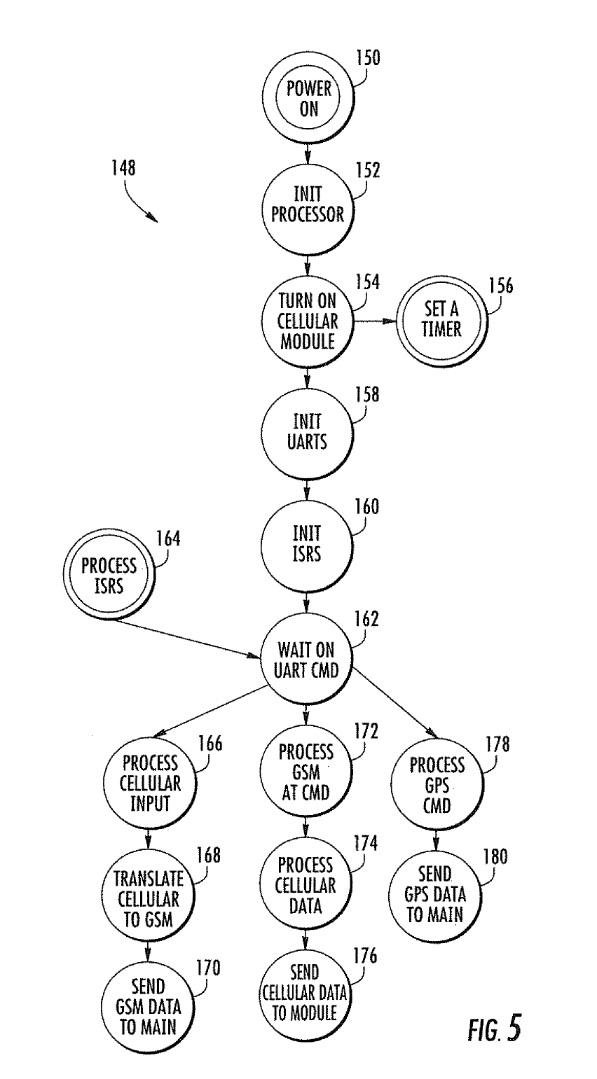

A state diagram 148 for the daughterboard 70 will now be discussed in reference to FIG. 5. Power is turned on at State 150, and the translation circuitry 80 is initialized at State 152. The wireless transceiver circuitry 74 is turned on at State 154. A timer is set in State 156. If the timer expires and the wireless transceiver circuitry 74 is not turned on, then another attempt is made to turn on the circuitry.

The UARTs interfaces of the translation circuitry 80 are initialized in State 158, and the ISRs are initialized in State 160. In State 162, the translation circuitry 80 waits for a UART command. ISRs are processed in State 164.

Next, three separate State paths may happen after receiving a UART command. In a first State path, in State 166, a received cellular input is processed, an AT command is translated from CDMA to GSM in State 168, and the GSM AT command is sent to the motherboard in State 170. In a second State path, in State 172, the translation circuitry 80 processes a GSM AT command from the motherboard 60 in State 172, processes CDMA data in State 174, and then sends the CDMA data to the wireless transceiver circuitry 74 in State 176. In a third State path, the translation circuitry 80 processes GPS data in State 178, and then sends the GPS data to the motherboard 60 in State 180.

The communications functions will now be further discussed. The translation circuitry 80 communicates to the motherboard 60 and the wireless transceiver circuitry 74, and provides a debug port that can also be used for provisioning. The debug port will be connected to the USB port on the wireless transceiver circuitry 74.

The wireless transceiver circuitry 74 default BAUD rate is 115200 for both the Main UART and the USB port. This does not necessarily need to change as it will allow faster data transfers of outgoing commands. A 9600 baud rate simply needs to be maintained to the motherboard 60. If data buffering to the translation circuitry 74 becomes an issue, the BAUD rate can be changed to 9600.

The board-to-board comm ports can be digital level TTL tx/rx with no RS-232 driver circuitry. The USB debug port is a 5 pin header, gnd, tx, 5V, rx, and gnd and a custom plug-in USB Dongle has the USB drive circuitry to enable a connection to a PC for debugging purposes and to provide a manual provisioning mechanism if required. The USB drive circuitry is routed on the daughterboard 70.

The Master Communications link is a low-level TTL interface between the translation circuitry 74 and the motherboard 60 using signals TX, RX and GND. The default BAUD rate is 9600, with no hardware flow control. No RS-232 driver circuitry should be required. All of the UART signals can be connected and have zero ohm resistors to isolate DCD, DTR, DSR, RTS, CTS and RING. PIN 41 on the GR47/GR48 GSM module is an input pin connected to the TX output pin on the motherboard 60. PIN 42 on the GR47/GR48 GSM module is an output pin connected to the RX input pin on the motherboard 60.

The translation circuitry 80 has a master input buffer for receiving AT commands from the motherboard 60. Input commands are buffered until the entire commands have been received. An AT command is then verified before it is translated and then transmitted to the wireless transceiver circuitry 74.

There is a translation circuitry to motherboard output buffer that transmits translated and processed AT command responses back to the motherboard 60 input buffer via the master card RX input pin.

The translation circuitry link is a low-level TTL interface between the translation circuitry 80 and the wireless transceiver circuitry 74 using signals TX, RX and GND. The default baud rate of the CC864 CDMA module is 115,200. The baud rate is changed to 9600 during the init state, and a verification is made to see that the baud rate is maintained during power off. This uses an automatic init cycle to detect and change the baud rate to 9600 if the translation circuitry 80 is run at 9600 instead of the default 115,200. Hardware flow control is used, but the full RS232 interface is implemented. No RS-232 driver circuitry is required. All of the UART signals can be connected with zero ohm resistors to isolate DCD, DTR, DSR, RTS, CTS and RING. Pin 26 on the wireless transceiver circuitry 74 is a TX output pin connected to the RX output pin on the motherboard 60. Pin 25 on the wireless transceiver circuitry 74 is an RX input pin connected to the TX output pin from the motherboard 60.

The translation circuitry 80 has an output buffer for the translated AT commands received and verified from the motherboard 60. Once commands have been verified they are transmitted to the wireless transceiver circuitry 74. Corresponding responses and acknowledgements are received in the input buffer and processed and translated as necessary and passed on to the motherboard 60. Each command supported from the motherboard 60 has a corresponding command for the wireless transceiver circuitry 74 in a look up table 80.

Example AT conversion commands are provided in TABLE 1. The listed AT command translations do not include the full set of AT commands. Instead, some of the necessary AT commands are provided.

TABLE 1

| | | Same | |
|---|---|---|---|
| | | as | |
| AT Commands to GSM Modem | Description | CDMA | CDMA Command |
| AT+IPR=9600 | | Y | AT+IPR=9600 |
| ATE=0 | | N | ATE0 |
| AT+CPBS=“SM” | Select SIM Card Memor | N | AT+CPBS=\“ME\” |
| AT+CPBR=? | Read Phone Book | Y | |
| | Entries | | |
| AT+CPBR=1,250 | Read Phone Book | Y | |
| | Entries | | |
| AT*E2EMM=1 | Ericson Engineering | N | |
| | Monitor Mode | | |
| AT+CMGF=1 | Set Format of | Y | AT+CMGF=1 |
| | Message to Text | | |
| AT+CSDH=1 | Show Text Mode | Y | AT+CSDH=1 |
| | Parameters in Result | | |
| | Codes | | |
| AT+CSCS=“GSM” | Select Character Set | N | AT+CSCS=“IRA” |
| AT+CSMP=17,167,0,0 | Set Text Mode | N | AT+CSMP=“1234567890”,409 |
| | Parameter | | 7,1,2 |
| AT+CPMS=“ME” | Preferred Message | Y | |
| | Storage, In Module | | |
| | Memory | | |
| AT+CMGF=0 | Set Format of | Y | AT+CMGF=0 |
| | Message to PDU | | |
| AT+CGATT=1 | GPRS Attach. | N | AT$QCMIP=N |
| | Connects Module for | | |
| | TCP/IP Connection. | | |
| AT+CGDCONT=1,“IP”,“internet | Define Packet Data | N | AT#SCFG=<connId>,<cid>,< |
| ” | Protocol (PDP) | | pktSz>,<maxTo>,<connTo>, |
| | Context. i.e. | | <txTo> |
| | specify that the | | |
| | connection protocol | | |
| | is IP. This might be | | |
| | the same as setting | | |
| | up a TCP/IP Socket | | |
| AT*ENAD=1,“”,“web”,“web”, | This command is used | N | |
| 1,0 | for defining an | | |
| | Internet Account. | | |
| | Ericsson Internet | | |
| | Account Define, | | |
| | AT*ENAD=[<index>] [,< | | |
| | name>,<userid>,<password | | |
| | >,<bearer>,(bearer | | |
| | _settings)]If | | |
| | <bearer>=1(bearer_settings | | |
| | ):=<pref_serv>, | | |
| | <p | | |
| | ap_chap> | | |
| AT*E2IPA=1,1 | M2M IP Activate, | N | |
| | Activate IP Session | | |
| AT*E2IP0=1,“79.171.34.59” | M2M IP cOnnect/Open | N | |
| ,48000 | | | |
| AT*E2IPC=1 | M2M IP Close | N | |
| | Connection | | |
| AT+CGATT=0 | GPRS Detach | N | |
| AT+CPMS=“ME” | Preferred Message | Y | |
| | Storage, In Module | | |
| | Memory | | |
| AT+CMGL=4 | List Messages, ALL | Y | |
| AT+CMGD=1 | Delete Message | Y | |
| AT+CMGS=“cell number” | Send Text Message | Y | 4.3.3 |
| SMS message content | | | |
| AT+CFUN=0 | Set ME Functionality | Y | AT+CFUN=0 |
| Cmgr | | | |

The debug port is for monitoring the wireless transceiver circuitry 74, invoking debug, diagnostic commands, provisioning commands and performing firmware upgrades. It is a 5 pin low level TTL interface with RX, TX, VCC and GND. For cost requirements, the RS232 driver circuitry may be installed on an external plug. The same driver circuitry may be routed on the daughterboard 70, but optionally populated with 0 ohm bypass resistors. The 5 pin connector pin-out, is as follows: pin 1—GND, pin 2—TX (Output Signal for data transmitted), pin 3—VCC, pin 4—RX (Input Signal for data received) and pin 5—GND.

Each cellular network has its own requirements for sending and receiving SMS messages, performing data calls and for provisioning cellular devices. Most of these commands have a common interface, but consideration for differences are taken into account. Comparison of module AT command sets and each network's requirements provides the comparison points. A mechanism may be used to set the user name and passwords, although these parameters may be stored in the CC864 CDMA module.

Each cellular provider uses a different PRI file that may be programmed into the modem (i.e., wireless transceiver circuitry 74) for the modem to register properly on their cellular network and connect. These PRI files are typically programmed in by the manufacturer of the RF module or by the designer using special programming software at the time of purchase. The following sections list different carriers and the details of activating modems on their networks, and where applicable, their username and password formats for making 1xRTT calls.

Sprint Provisioning is typically network initiated (IOTA) but can also be manually initiated if the IOTA fails and the user cannot wait for another IOTA provisioning to be initiated. The 3GPD parameters are easily configured using the Over The Air Provisioning. Sprint PCS uses IOTA (IP-based Over The Air) for their Over The Air provisioning system. IOTA uses packet data calls to transfer the configuration data to the phone. These IOTA data sessions can be Network initiated or Client initiated.

Network Initiated IOTA may be the preferred method. An automatic Network Initiated IOTA session occurs when the module first registers onto the Sprint network. This IOTA session is queued when Sprint originally sets up and activates the account. In their current implementation, Sprint imposes a 72 hour expiration timer for this queued IOTA session.

An IOTA session has a device time out of 15 minutes. If there is no success within 15 minutes, the status will change to fail and the module will stop trying. A normal IOTA session takes from 1 to 3 minutes. To register onto the network the wireless transceiver circuitry 74 needs to have sufficient signal and have been manually provisioned with the MDN and MSID.

The IOTA session will occur and populate the 3GPD parameters. If it is the first IOTA session, it is called a Network Initiated Initial Provisioning (NIIP). An IOTA session needs to occur while the wireless transceiver circuitry 74 has a sufficient signal and is registered on the Sprint PCS Network. A session will not be able to be successful if the wireless transceiver circuitry 74 is out of coverage or not properly registered on the Sprint PCS network.

The following commands may be used to program the wireless transceiver circuitry 74. These settings may need to be modified to match the selected RF module, as readily appreciated by those skilled in the art.

AT$KWMODE=1

AT$KWSPC=Unlock/Activation Code (6 or 7 digits supplied by Sprint)

AT$KWDIR=10-Digit (MDN) Directory Phone Number From Cellular Carrier (Without Hyphens)

AT$KWNSID=10-Digit (MIN) Number From Cellular Carrier (Without Hyphens). This only needs to be entered if different than the MDN.

AT$KWMODE=2

Power off the modem (i.e., the wireless transceiver circuitry 74) for 15 seconds. Power on the modem, wait 5 to 10 minutes to register on the network.

AT+CDV<Cell Phone Number> Call your cell phone to test that it activated, when it rings, confirm the number matches, answer and then hang-up to disconnect the call. The angle brackets do not need to be entered, just the cell phone number with no spaces.

Sprint does not use a username and password when connecting with a Dial-Up-Networking (DUN) session, as they are stored automatically in the Module during the IOTA provisioning.

Dial: #777

Username: Leave Blank

Password: Leave Blank

With respect to Verizon Provisioning, some of the specific AT commands may also need to be updated to match the selected module, as readily appreciated by those skilled in the art.

Verizon cellular modules support the service provisioning features called Over-the-Air Service Provisioning (OTASP) and Over-the-Air Parameter Administration (OTAPA). OTASP occurs when a user initiates a call to the service provider. No further commands are typically required to provision the modem. For example, a user who gets a new modem/phone without any service programming data can call the service provider's special OTASP number to have the device programmed without physically taking it to the service provider. OTAPA occurs when the network initiates a call to the wireless transceiver circuitry 74 and programs it without any user intervention. OTAPA is typically used when the service provider decides to update information on many cellular devices at the same time.

After the modem's serial number is authorized for use with a cellular provider, the wireless transceiver circuitry 74 may be activated over the cellular network. To perform Over-the-Air Service Provisioning, ensure the antenna is properly attached and a good signal is present. Type in AT$KWDIR? to query the wireless transceiver circuitry 74 and determine the currently programmed phone number. The result should be something like $KWDIR: 0000005555. Note the number. Also check the PRL number with AT+GMR, note the number, and now type: AT+CDV*22899.

After issuing the AT+CDV*22899 command, the cellular provider will program the proper roaming parameters into the wireless transceiver circuitry 74. Allow approximately four minutes for this to occur. After waiting the appropriate amount of time for the cellular network to program the wireless transceiver circuitry 74, perform a power cycle by removing the DC power supply plug and reconnecting it.

Query the wireless transceiver circuitry 74 to see if the phone number on the account has been assigned to the wireless transceiver circuitry with the AT$KWDIR? command. If the OTASP was successful the phone number should be displayed; i.e., $KWDIR: 9544305811. The PRL number may be replaced with a newer revision by the carrier, (AT+GMR). To further test that OTASP has taken place, type: AT+CDV<phone number to call> from terminal emulation software. Example: AT+CDV9544305811

If this is successful, the wireless transceiver circuitry 74 will place an outbound call through the cellular network to the phone number specified. To make a circuit-switched connection, type this command: ATD<phone number to call>.

If the wireless transceiver circuitry 74 did not properly dial the phone number specified, the following may be checked. First, make certain that hyphens or spaces are not being used in the ATD dialing string. For example, ATD9544305811 should be entered. After verifying that the dialing string has been properly entered, if the wireless transceiver circuitry 74 still will not place an outbound call, the phone number may have to be entered into the wireless transceiver circuitry 74 before performing an Over-the-Air Provision.

Verizon manual subscriber provisioning will now be described. This applies to Verizon Wireless subscribers residing in the United States who have communications between a computer and the wireless transceiver circuitry 74, but cannot place inbound or outbound calls through the cellular network. Some of the commands may need to be modified to match the selected modules AT command set.

For a Verizon Wireless subscriber residing in the United States, the standard procedure is to have the wireless transceiver circuitry 74 provisioned by issuing the command AT+CDV*22899. If the wireless transceiver circuitry 74 will respond and a verification has been made with Verizon that the serial number is activated in its system, the phone number may have to be manually keyed. In cellular terminology, the phone number is known as the Mobile Directory Number (MDN), which is the number to call to connect to the wireless transceiver circuitry 74 and can be entered as described below. Enter these commands via the terminal emulation software:

AT+GMR

AT$KWMODE=1

AT$KWSPC=000000

AT$KWDIR=10-Digit MDN Phone Number From Verizon (Without Hyphens)

AT$KWMSID=10-Digit (MIN) Number From Cellular Carrier (Without Hyphens). This only needs to be entered if different than the MDN.

AT$KWMODE=2

AT+CDV*22899

After issuing the last command listed above, let the wireless transceiver circuitry 74 sit uninterrupted for four minutes. After four minutes, remove the power supply jack from the wireless transceiver circuitry 74 and reinsert it several seconds later. Reconnect via terminal emulation and query the unit with the following commands:

AT$KWMODE?

AT$KWDIR?

AT+GMR

AT+CDV<Cell Phone Number> Call the wireless transceiver circuitry 74 to test that it activated, when it rings, confirm the number matches, answer and then hang-up to disconnect the call. Do not enter the angle brackets, just the cell phone number with no spaces.

The first command should return the number 0 as a reply, and the second should return the phone number for the wireless transceiver circuitry 74. The third will print out the module firmware version, followed by the PRL number loaded in by Verizon's network, if different than before, and then OTASP has occurred. The functionality of the wireless transceiver circuitry 74 may be tested.

A Verizon 1xRTT TCP/IP connections is performed as follows:

| | |
|---|---|
| Dial: | #777 |
| User Name: | MDN@vzw3g.com i.e. 5551234567@vzw3g.com |
| Password: | vzw |
| Mobile IP | |
| Dial: | #777 |
| User Name: | Leave Blank |
| Password: | Leave Blank |

Other cellular network provisioning will have variations on the above two schemes, and the use of the debug port will enable the provisioning of the wireless transceiver circuitry 74. Some cellular networks use a SIM card. If there is a SIM card on the motherboard 60, to this SIM card may be through the 60 pin interface on the motherboard. Some carriers (T-Mobile) may support multiple IMSI profiles, which would allow GSM devices to have support on multiple carriers.

The translation circuitry 80 will plug into a 60-pin connector on the motherboard 60 and emulate the GR47/GR48 GSM module that has been removed. The use of an extended plug may provide additional board to board clearance so that the daughterboard 70 has enough space to mount the translation circuitry 80 and the other required parts on the bottom of the card. The wireless transceiver circuitry 74 is smaller than the GR47/GR48 GSM module and space may be available on both sides for component placement.

For ease of manufacture, the selected wireless transceiver circuitry 74 may be a plug-in module that can be mounted to the daughterboard 70 with the use of mounting hardware. This way only a connector needs to be affixed to the wireless transceiver circuitry 74 side of the daughterboard 70, which simplifies manufacture and enables an easy swap out of the selected module.

The translation circuitry 80 is a low power microprocessor to retain the battery life of the electronic tracking device 10. For example, the translation circuitry 80 should run off 3.3 volts. The translation circuitry 80 requires 3 UARTs to talk to the motherboard 60, the wireless transceiver circuitry 74, and optionally, provide a Debug Daughter Interface to sniff the traffic between the motherboard and the translation circuitry. The translation circuitry 74 also has enough RAM to buffer the serial ports and provide translation.

The CC864 CDMA module selected for the wireless transceiver circuitry 74 has a USB port that can be direct connected via USB driver chips and no processor interface is required. This provides a Module Debug and Provisioning port. The Module Debug port talks directly to the attached module and requires no translation.

In terms of electrical specifications, the motherboard supplies 3.6 Volts to the GR47/GR49 GSM module and the processing circuitry 62 on the motherboard 60 and runs off of 3.3 Volts. The CC864 GSM module has a recommended digital interface voltage of 2.6 Volts, with a maximum voltage is 2.9 Volts.

In terms of connectors, the CC864 GSM module is equipped with a Molex 80-pin board-to-board connector, P/N 0539490878 (male). The mating part is Molex P/N 0541500878 (female). The CC864 GSM module is equipped with a Murata GSC type 50 Ohm RF connector, P/N MM9329-2700. The suitable counterpart is Murata MXTK92 type or MXTK88 type connector.

The daughterboard 70 has a 60 pin male connector that plugs into a female socket connector on the motherboard 60.

The GR47/GR48 GSM module is 33 mm×50 mm, and 6.82 mm thick. The bottom of board is 4.41 mm, with a 2.70 mm closed can. Pins extend 1.71 mm past the can. The CC864 CDMA module is smaller, at 32.8 mm×36.2 mm. This leaves some room on top for parts. Mounting holes are not needed on the motherboard 60 to lock down the CC864 CDMA module since it simply plugs into the 60 pin header.

Pin-out of the CC864 CDMA module will now be described. When viewed from the top, with the connector running from left to right, Pin 1 is on the left with Pin 2 below it. Pin 1 is closest to the center of the module. Pin 59 is on the right side, closest to the center, with pin 60 below.

A pin-out of the motherboard 60 is provided in TABLE 2.

TABLE 2
Motherboard Electrical Pin-out

| Pin | Signal Name | Dir | Signal Type | Description | Req'd |
|---|---|---|---|---|---|
| 1 | VCC | — | Supply | Power Supply | Y |
| 2 | DGND | — | — | Digital Ground | Y |
| 3 | VCC | — | Supply | Power Supply | Y |
| 4 | DGND | — | — | Digital Ground | Y |
| 5 | VCC | — | Supply | Power Supply | Y |
| 6 | DGND | — | — | Digital Ground | Y |
| 7 | VCC | — | Supply | Power Supply | Y |
| 8 | DGND | — | — | Digital Ground | Y |
| 9 | VCC | — | Supply | Power Supply | Y |
| 10 | DGND | — | — | Digital Ground | Y |
| 11 | ChG_IN | — | Batt Charge | Battery charging | Y |
| 12 | DGND | — | — | Digital Ground | Y |
| 13 | IO5 | I/O | Dig 2.75 | General Purpose input/output 5 | N |
| | ADC4 | I | Analogue | Analogue to digital converter 4 | |
| 14 | ON/OFF | I | Internal pull up, open | Turns the module on/off. Former WAKE_B, | Y |
| | | | drain | | |
| 15 | SIMVCC | — | Dig. 3/5 V | SIM card power supply, Power output for SIM Card | Y |
| | | | | from module | |
| 16 | SIMPRESENCE | I | Internal pull up, open | SIM Presence, A “1” shall indicate that the SIM is | y |
| | | | drain | missing; a “0” that it is inserted. | |
| 17 | SIMRST | O | Dig. 3/5 V | SIM card reset | Y |
| 18 | SIMDATA | I/O | Dig. 3/5 V | SIM card data | Y |
| 19 | SIMCLK | O | Dig. 3/5 V | SIM card clock | Y |
| 20 | DAC | O | Analogue | Digital to Analogue converter | N |
| 21 | IO1 | I/O | Digital, 2.75 | General purpose input/output 1 | N |
| | KEYROW2 | I | | Keyboard row 2 | |
| 22 | IO2 | I/O | Digital, 2.75 | General purpose input/output 2 | N |
| | ADC 5 | I | Analogue | Analog to digital converter 5 | |
| 23 | IO3 | I/O | Digital, 2.75 | General purpose input/output 3 | N |
| | KEYROW3 | I | | Keyboard row 3 | |
| 24 | IO4 | I/O | Digital, 2.75 | General purpose input/output 4 | N |
| | KEYROW4 | I | | Keyboard row 4 | |
| 25 | VRTC | I | Supply 1.8 V | Voltage for real time clock | N |
| 26 | ADC1 | I | Analogue | Analogue to digital converter 1 | N |
| 27 | ADC2 | I | Analogue | Analogue to digital converter 2 | N |
| 28 | ADC3 | I | Analogue | Analogue to digital converter 3 | N |
| 29 | SDA | I/O | 2.75, internal pullup | I2C Data | N |
| 30 | SCL | O | 2.75, internal pullup | I2C Clock | N |
| 31 | BUZZER | O | Dig. 2.75 | Buzzer output from module | N |
| 32 | O3 | O | Dig. 2.75 | General purpose output 5 | N |
| | KEYCOL3 | O | | Keyboard column 3 | |
| | DSR | O | | Data Set Ready | |
| 33 | LED | O | Dig. 2.75 | Flashing LED | N |
| | IO6 | I/O | | General purpose I/O 6 | |
| 34 | VIO | O | Power Out | Module powered indication | Y |
| | | | 2.75 | The VIO is a 2.75 V output that could power external | |
| | | | | devices to transmit data towards the GSM device to a | |
| | | | | 75 mA max. | |
| 35 | TX_ON | O | Dig 2.75 | This output shall indicate when the GSM module is | N |
| | | | | going to transmit the burst. | |
| 36 | RI | O | Dig. 2.75 | Ring Indicator | Y |
| | KEYCOL2 | O | | Keyboard column 2 | |
| | O2 | O | | General purpose output 2 | Y |
| 37 | DTR | I | Dig. 2.75 | Data Terminal Ready | |
| | KEYROW1 | I | | Keyboard row 1 | |
| | IN1 | I | | General purpose input 1 | |
| 38 | DCD | O | Dig. 2.75 | Data Carrier Detect | Y |
| | KEYCOL1 | O | | Keyboard column 1 | |
| | O1 | O | | General purpose output 1 | |
| 39 | RTS | I | Dig. 2.75 | Request To Send | Y |
| | IO9 | I/O | | General purpose I/O 9 | |
| 40 | CTS | O | Dig. 2.75 | Clear To Send | Y |
| | KEYCOL4 | O | | Keyboard column 4 | |
| | O4 | O | | General purpose output 4 | |
| 41 | TD | I | Dig. 2.75 | Transmitted Data [former DTMS] | Y |
| 42 | RD | O | Dig. 2.75 | Received Data [former DFMS] | Y |
| 43 | TD3 | I | Dig. 2.75 | UART3 Transmission | N |
| | I/O7 | I/O | | General purpose I/O 7 | |
| 44 | RD3 | O | Dig. 2.75 | UART3 Reception | N |
| | I/O8 | I/O | | General purpose I/O 8 | |
| 45 | TD2 | I | Dig. 2.75 | UART2 Reception [Former CTMS] | N |
| 46 | RD2 | O | Dig. 2.75 | UART2 Transmission [Former CFMS] | N |
| 47 | PCMULD | I | Dig. 2.75 | DSP PCM digital audio input | N |
| 48 | PCMDLD | O | Dig. 2.75 | DSP PCM digital audio output | N |
| 49 | PCMO | O | Dig. 2.75 | Codec PCM digital audio output | N |
| 50 | PCMI | I | Dig. 2.75 | Codec PCM digital audio input | N |
| 51 | PCMSYNC | O | Dig. 2.75 | DSP PCM frame sync | N |
| 52 | PCMCLK | O | Dig. 2.75 | DSP PCM clock output | N |
| 53 | MICP | I | Analogue | Microphone input positive | N |
| 54 | MICN | I | Analogue | Microphone input negative | N |
| 55 | BEARP | O | Analogue | Speaker output positive | N |
| 56 | BEARN | O | Analogue | Speaker output negative | N |
| 57 | AFMS | O | Analogue | Audio output from module | N |
| 58 | SERVICE | I | 12 V/2.7 V | Flash programming voltage for the MS. Enable logger | N |
| | | | | information if no | |
| 59 | ATMS | I | Analogue | Audio input to module | N |
| 60 | AGND | — | Analogue | Analogue ground | Y |

For the CC864 CDMA module, not all pins will be implemented. Some of the unused pins may require termination, pull-ups or pull-downs. The translation circuitry 74 output to the CC864 CDMA is limited to 2.6 volts to prevent damage to the module. The SIM output signals and the SIMVCC supply can continuously withstand a short circuit to any voltage within the range from 0V to 4.1V.

In terms of grounds, the GR47/GR48 GSM module had separate AGND and DGND. They were not connected together in the module and should be provided as separate grounds to the wireless transceiver circuitry 74, or they should be remain separated on the daughterboard 70 and only connected internally in the CC864 CDMA module. The AGND in the GR47/GR48 GSM module is for the Analog Audio Reference for ATMS and AFMS. There is a corresponding signal in the CC864 CDMA module. The DGND is the reference for all digital signals and the VCC power supply. The GR47/GR48 GSM module is limited to 0.5 A per pin, with an Imax of 600 mA and 100 mA per pin.

In terms of the power supply, the CC864 CDMA module typically requires 3.8 Volts. The motherboard 60 provides 3.6 volts. The Normal Operating Range is 3.4V to 4.2V, so this value is acceptable, except the peak current may be higher as the voltage is slightly lower. Based upon this an LVDO may be used to regulate the translation circuitry 80 to 2.6V for communications between the wireless transceiver circuitry 74 and the motherboard or set the UART output pins to 2.6 volts if the translation circuitry supports this option.

If a battery charging input is used, then it is controlled by the motherboard 60. In terms of on/off and external power signals, Pin 14 is for the on/off signal and Pin 34 is the external power supply signal. The motherboard 60 issues an AT command to power down the wireless transceiver module 74, AT+FUN=0<CR>. Then a time delay is invoked allowing the wireless transceiver circuitry 74 to shutdown and disconnect from the network, and power is then completely removed. A software command can be implemented and optionally, the hardware interface can be used to shutdown and power up the wireless transceiver module 74 as well. The hardware control circuitry should be installed with a bypass option.

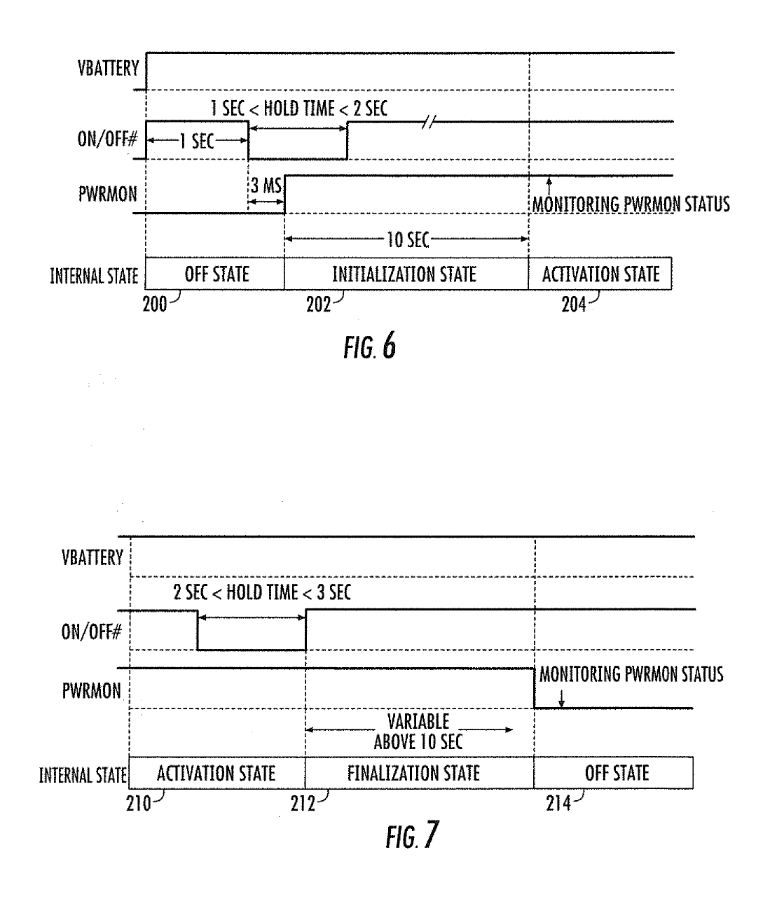

Referring now to FIG. 6, to turn on the wireless transceiver circuitry 74, the pad ON# needs to be tied low for at least 1 second and then released. The maximum current that can be drained from the ON# pad is 0.1 mA. In terms of a Power On Sequence, the wireless transceiver circuitry 74 should not be accessed for at least 10 seconds after it has been turned on. As shown in FIG. 6, there is an OFF state 200, followed by an initialization state 202 and then an activation state 204. The CC864 CDMA module is not activated immediately after power up because the boot sequence of the module needs to complete. It takes about 10 seconds to initialize the CC864 CDMA module internally. For this reason, the CC864 CDMA module is not accessed during the initialization state 202. To get the desirable stability, the CC864 CDMA module needs at least 10 seconds after the PWRMON goes HIGH.

To check if the CC864 CDMA module has powered on, the hardware line PWRMON is to be monitored. When PWRMON goes high, the module has powered on. A pull-up resistor on the ON# line is not used since it is internally pulled up. Using a pull up resistor may cause latch up problems on the CC864 CDMA module power regulator and improper power on/off of the module. The line ON# is connected in an open collector configuration. As discussed herein, all the lines are inverted. Active low signals are labeled with a name ending with “#” or with a bar over the name. The CC864 CDMA module may be turned on also by supplying power to the charge pad provided there is a battery on the VBATT pads.

Referring now to FIG. 7, in terms of turning off the wireless transceiver circuitry 74, it may be turned off with either a software command or a hardware shutdown circuit. When the device is shut down, it notifies the network that it is powering down and is therefore no longer reachable. The power should not be disconnected before the power off procedure is completed. This may damage wireless transceiver circuitry 74 and render it inoperable.

As shown in FIG. 7, there is an Activation state 210, followed by a Finalization state 212 and then an Off state 214. To turn the CC864 CDMA module off, the ON/OFF Pin is tied low for 2 second and then released. The same circuitry and timing used for powering on the module can be used for powering off the module. The device shuts down after the ON OFF pin is released. When the hold time of ON/OFF# is above 2 seconds, the CC864 CDMA module goes into the Finalization state 212 and finally will shut down PWRMON at the end of this state, which is the Off state 214.

The period of the Finalization state 212 can differ according to the situation in which the CC864 CDMA module is so it cannot be fixed definitely. Normally, it will be above 10 seconds later from releasing ON/OFF# and DTE should monitor the status of PWRMON to see the actual power off. To check if the device has powered off, hardware line PWRMON is monitored. When PWRMON goes low, the device has powered off.

The AT command set and its syntax will now be discussed. The AT command includes a Prefix, Body, and Termination Characters, and are as follows:

| Prefix AT | |
|---|---|
| Body Basic Command | T |
| Basic Command with Parameters CFUN=0 | |
| Extended Command | AT+<BODY> or AT*<BODY> |
| Termination Char <CR> | |

Read Commands are terminated with a ? to read values from the device.
Test Commands are terminated with a =? to read values from the device.

For the AT Response Syntax, formats for the result codes are:

Basic format result code, such as OK. The Basic result code also has a numerical equivalent.
Extended format result code, prefixed with a plus sign (+) or an asterisk (*):

| | |
|---|---|
| - AT+<command>: | <parameter > |
| - AT*<command>: | <parameter> |

where the <parameter> is the result code value, note that a single space character separates the colon character from the <parameter>. If several values are included in the result code, they are separated by commas. It is also possible that a result code has no value. The extended syntax result codes have no numerical equivalent. They are issued in alphabetical form.
Information text response may contain multiple lines separated by <CR>. The TE detects the end of informational text responses by looking for a final result code response, such as OK.
Only commands that do not have an exact match need to be translated. The Result Codes are provided in TABLE 3.

TABLE 3
Result Codes

| Value | General meaning |
|---|---|
| OK | Command executed, no errors |
| ERROR | Invalid command or command line too long |
| NO | No dialing possible, wrong mode |
| DIALTONE | |
| BUSY | Remote station busy |
| NO ANSWER | Connection completion time-out |
| NO CARRIER | Link not established or disconnected |

There are four groups of commands as far as the translation interface is required.

1. Matching commands, with matching Results
2. Matching commands, with non-matching results
3. Non-Matching commands are supported, i.e. translated.
4. Non-Matching commands that do not need to be supported.

SMS text mode allows users to send SMSs without having to understand how PDUs are constructed. This section describes how to carry out basic operations in text mode and explains the steps that need to be taken.

For a Basic transmission of SMS, a script which sets the module up is shown below:

| AT+CSDH=1 | Enable the use of text mode parameters |
|---|---|
| OK | |
| AT+CSMP=17,167 | Set text mode parameter |
| OK | |
| AT+CMGF=1 | Switch the module to text mode |
| OK | |
| AT+CMGS=“07787154042” Sending an SMS | |
| > Test SMS-> | The text must be ended, as in PDU mode, |
| with a control-Z character | |
| +CMGS: 204 | Confirmation that the SMS has been sent |

successfully
OK

1. Once the CSDH, CSMP and CMGF commands have been carried out they will not need to be initialized for this session.
2. These parameters are saved in NVRAM using the &W command.

New message indications are similar to the PDU mode as shown below:

AT+CNMI=3,1
OK
+CMTI: “SM”,2
AT+CNMI=3,2
OK
+CMT:“+447747008670”,“Matt
L”,“02/11/19,09:58:42+00”,145,36,0,0,“+447785016005”
,145,8
Test sms

The CMT indication may not have a CR/LF appended to the end of the SMS data. If the SMS contains one it will be displayed. Otherwise, the application will need to recognize the CMT line and the length character, in this case 8 and count the characters into its input buffer.

Reading messages is performed as in PDU mode.

AT+CMGR=2
+CMGR: “REC UNREAD”,“+447747008670”,“Matt L”,“02/11/
19,09:57:28+00”,145,36,0,0,“
+447785016005”,145,8
Test sms
OK

In terms of listing messages, PDU mode numbers are used as parameters. In text mode letters are used instead and these must be upper case as the module does not accept lower case commands. See the example below:

AT+CMGL=“ALL”
+CMGL: 1,“REC READ”,“+447747008670”,“Matt L”,“02/10/
21,10:07:23+04”,145,4
Test
+CMGL: 2,“REC READ”,“+447747008670”,“Matt L”,“02/11/
19,09:57:28+00”,145,8
Test sms
+CMGL: 3,“REC UNREAD”,“+447747008670”,“Matt L”,“02/11/
19,09:58:06+00”,145,8
Test sms
OK

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included.

That which is claimed is:

1. An electronic tracking device comprising:
a housing;
a motherboard carried by said housing and comprising processing circuitry configured to operate using a first command set corresponding to a first wireless communications protocol; and
a daughterboard coupled to said motherboard and comprising
tracking circuitry,
wireless transceiver circuitry coupled to said tracking circuitry and configured to operate using a second command set corresponding to a second wireless communications protocol, and
translation circuitry coupled between said wireless transceiver circuitry and said processing circuitry to provide bidirectional translation between the first and second command sets.

2. The electronic tracking device according to claim 1 wherein the first and second command sets comprise respective first and second modem command sets.

3. The electronic tracking device according to claim 1 wherein the first command set comprises an AT command set for a GSM protocol; and wherein the first wireless communications protocol comprises the GSM protocol.

4. The electronic tracking device according to claim 1 wherein the second command set comprises an AT command set for a CDMA protocol; and wherein the second wireless communications protocol comprises the CDMA protocol.

5. The electronic tracking device according to claim 1 wherein said motherboard further comprises a motherboard connector; and wherein said daughterboard further comprises a daughterboard connector mated with said motherboard connector.

6. The electronic tracking device according to claim 1 wherein said tracking circuitry comprises GPS circuitry.

7. The electronic tracking device according to claim 6 further comprising a GPS antenna carried by said housing and coupled to said GPS circuitry.

8. The electronic tracking device according to claim 1 further comprising at least one battery carried by said housing and coupled to said motherboard and daughterboard.

9. The electronic tracking device according to claim 8 wherein said housing comprises:
mating first and second housing portions, with said first portion carrying said motherboard and daughterboard, and said second portion carrying said at least one battery; and
a partition between said first and second housing portions.

10. An electronic tracking device comprising:
a housing;
a motherboard carried by said housing and comprising processing circuitry configured to operate using a first modem command set corresponding to a first cellular communications protocol; and
a daughterboard coupled to said motherboard and comprising
GPS circuitry,
wireless transceiver circuitry coupled to said GPS circuitry and configured to operate using a second modem command set corresponding to a second cellular communications protocol, and
translation circuitry coupled between said wireless transceiver circuitry and said processing circuitry to provide bidirectional translation between the first and second modem command sets.

11. The electronic tracking device according to claim 10 wherein the first modem command set comprises an AT command set for a GSM protocol; and wherein the first cellular communications protocol comprises the GSM protocol.

12. The electronic tracking device according to claim 10 wherein the second modem command set comprises an AT command set for a CDMA protocol; and wherein the second cellular communications protocol comprises the CDMA protocol.

13. The electronic tracking device according to claim 10 further comprising a GPS antenna carried by said housing and coupled to said GPS circuitry.

14. The electronic tracking device according to claim 10 further comprising at least one battery carried by said housing and coupled to said motherboard and daughterboard.

15. The electronic tracking device according to claim 14 wherein said housing comprises:
mating first and second housing portions, with said first portion carrying said motherboard and daughterboard, and said second portion carrying said at least one battery; and
a partition between said first and second housing portions.

16. A daughterboard to be coupled to a motherboard in an electronic tracking device, the motherboard comprising processing circuitry configured to operate using a first command set corresponding to a first wireless communications protocol, and the daughterboard comprising:
tracking circuitry;
wireless transceiver circuitry coupled to said tracking circuitry and configured to operate using a second command set corresponding to a second wireless communications protocol; and
translation circuitry to be coupled between said wireless transceiver circuitry and the processing circuitry to provide bidirectional translation between the first and second command sets.

17. The daughterboard according to claim 16 wherein the first command set comprises an AT command set for a GSM protocol; and wherein the first wireless communications protocol comprises the GSM protocol.

18. The daughterboard according to claim 16 wherein the second command set comprises an AT command set for a CDMA protocol; and wherein the second wireless communications protocol comprises the CDMA protocol.

19. The daughterboard according to claim 16 wherein the motherboard further comprises a motherboard connector; and further comprising a daughterboard connector to be mated with the motherboard connector.

20. The daughterboard according to claim 16 wherein said tracking circuitry comprises GPS circuitry, and a GPS antenna coupled thereto.

21. A method for operating an electronic tracking device comprising a housing, a motherboard carried by the housing and comprising processing circuitry, and a daughterboard coupled to the motherboard and comprising tracking circuitry, wireless transceiver circuitry coupled to the tracking circuitry, and translation circuitry, the method comprising:
operating the processing circuitry using a first command set corresponding to a first wireless communications protocol;
operating the wireless transceiver circuitry using a second command set corresponding to a second wireless communications protocol; and
operating the translation circuitry coupled between the wireless transceiver circuitry and the processing circuitry to provide bidirectional translation between the first and second command sets.

22. The method according to claim 21 wherein the first and second command sets comprise respective first and second modem command sets.

23. The method according to claim 21 wherein the first command set comprises an AT command set for a GSM protocol; and wherein the first wireless communications protocol comprises the GSM protocol.

24. The method according to claim 21 wherein the second command set comprises an AT command set for a CDMA protocol; and wherein the second wireless communications protocol comprises the CDMA protocol.

25. The method according to claim 21 wherein the tracking circuitry comprises GPS circuitry.
